(19) United States
(12) Patent Application Publication
(10) Pub. No.: US 2017/0004859 A1
(43) Pub. Date: Jan. 5, 2017

(54) USER CREATED TEXTBOOK

(71) Applicant: COURSERA, INC., Mountain View, CA (US)

(72) Inventor: Jaran CHARUMILIND, Palo Alto, CA (US)

(21) Appl. No.: 14/788,773

(22) Filed: Jun. 30, 2015

(51) Int. Cl. G11B 27/031; G11B 27/32; G11B 27/34; G06F 3/0482; G06F 3/0484

(52) U.S. Cl. CPC G11B 27/031; G06F 3/0482; G06F 3/04842; G11B 27/34; G11B 27/326; G11B 27/327

(57) ABSTRACT

In one general aspect, a method for generating a digital textbook can include receiving, by a computing device, a time-based transcript of a video of an online lecture, receiving a time-based thumbnail image subset of images included in the video of the online lecture, and displaying at least a portion of the transcript including a particular word. The method can further include receiving a selection of the particular word, determining a first thumbnail image and a second thumbnail image associated with the particular word, displaying the first thumbnail image and the second thumbnail image, receiving a selection of the first thumbnail image, and modifying, based on the selection of the first thumbnail image, the time-based transcript by including the first thumbnail image in the time-based transcript. The method can further include storing the modified time-based transcript as the digital textbook.

### TECHNICAL FIELD

This description generally relates to creating a user textbook from a transcript of an online course lecture.

### BACKGROUND

A user on a computing device can navigate to a website that can provide a selection of online courses (online lectures) on a variety of subjects. The online courses can be videos that a user can watch on a display device included in the computing device. The videos can include audio content and visual content. The computing device can play the audio content on one or more speakers included on the computing device, synchronously with providing visual content for display on the display device. The video can show an image of a lecturer (the person giving the online video course (e.g., a professor)) interspersed with images of exhibits presented during the online lecture by the lecturer. For example, the exhibits can be figures, charts, equations, models, and other visual aids that can help with the teaching of the online course.

A user can also access transcripts for an online course. The transcripts can include the text of the lecture. The transcript will not include any images of the exhibits presented during the online lecture. The transcript can include words for everything said by the lecturer during the course lecture including fillers that may not contribute to the content of the lecture (e.g., “um”, “uh”, “er”, “uh-huh”, “well”, “like”).

### SUMMARY

In one general aspect, a method for generating a digital textbook can include receiving, by a computing device, a time-based transcript of a video of an online lecture. The transcript can include a plurality of words and a plurality of time indicators. Each time indicator included in the plurality of time indicators can be associated with a word from the plurality of words included in the transcript. The method can further include receiving, by the computing device, a time-based thumbnail image subset of images included in the video of the online lecture. The time-based thumbnail image subset can include a plurality of thumbnail images. Each of the plurality of thumbnail images can be associated with a respective time frame. The method also can include displaying, in a user interface on a display device included in the computing device, at least a portion of the transcript. The portion of the transcript can include a particular word. The method can further include receiving, from the user interface, a selection of the particular word. The method can further include determining, based on the selection of the particular word, a first thumbnail image and a second thumbnail image associated with the particular word. The first thumbnail image and the second thumbnail image can be included in the plurality of thumbnail images. The method can further include displaying, in the user interface, the first thumbnail image and the second thumbnail image. The method can further include receiving, from the user interface, a selection of the first thumbnail image. The method can further include, based on the selection of the first thumbnail image, modifying the time-based transcript by including the first thumbnail image in the time-based transcript. The method can further include storing the modified time-based transcript as the digital textbook.

Example implementations may include one or more of the following features. For instance, each time indicator included in the plurality of time indicators can indicate a time frame during which the associated word is spoken during the online lecture. Each respective time frame can indicate a time frame during which the associated thumbnail image is displayed on the display device. A number of thumbnail images included in the time-based thumbnail image subset can be less than a number of thumbnail images identified as included in the video of the online lecture. The number of thumbnail images included in the time-based thumbnail image subset can be based on determining scene transitions in a visual content of the video of the online lecture. Determining a first thumbnail image associated with the particular word and a second thumbnail image associated with the particular word can include determining that a time frame associated with the first thumbnail image occurs at least in part before a time indictor associated with the particular word, and determining that a time frame associated with the second thumbnail image occurs at least in part after the time indictor associated with the particular word. The method can further include receiving, from the user interface, a selection of a filler included in the time-based transcript for removal from the time-based transcript, and removing the filler from the time-based transcript, the removing further modifying the time-based transcript. The method can further include receiving, from the user interface, input data for including in the time-based transcript, and adding the input data to the time-based transcript, the adding further modifying the time-based transcript.

In another general aspect, a method can include retrieving an online lecture from a database of online lectures, determining time-based visual content for the online lecture, the time-based visual content including frames of images, determining time-based audio content for the online lecture, generating a set of time-based thumbnail images based on the time-based visual content, and generating a time-based transcript based on the time-based audio content. The time-based thumbnail images and the time-based audio content can be synchronized with a timeline. The method can further include identifying a scene cut as a time on the timeline where a measurable difference occurs between two consecutive thumbnail images included in the set of time-based thumbnail images, generating a subset of the time-based thumbnail images that includes thumbnail images located at identified scene cuts. The subset of the time-based thumbnail images may not include duplicate thumbnail images of frames of images that occur between scene cuts. The method can further include providing the subset of the time-based thumbnail images and the time-based transcript for use by a textbook generator to generate a digital textbook.

Example implementations may include one or more of the following features. For instance, the time-based transcript can include a plurality of words and a plurality of time indicators. Each time indicator included in the plurality of time indicators can be associated with a word from the plurality of words included in the transcript. Each word included in the plurality of words included in the time-based transcript can be associated with at least one of the thumbnail images included in the subset of the time-based thumbnail images. The association can be based on at least a partial overlapping of a time frame associated with a thumbnail image and a time frame associated with an occurrence of the word in the transcript.

In yet another general aspect, a system can include a computer system and a computing device. The computer system can include a database including a plurality of videos of online courses, and a server including a course application, a transcript generator, and a thumbnail generator. The course application can be configured to retrieve a video of an online course from the plurality of videos of online courses included in the database, and identify a time-based visual content and a time-based audio content of the video of the online course. The identifying can be based on using a timeline. The course application can be further configured to provide the time-based audio content to the transcript generator. The transcript generator can be configured to generate a time-based transcript based on the time-based audio content, and to provide the time-based visual content to the thumbnail generator. The thumbnail generator can be configured to generate a set of time-based thumbnail images based on the time-based visual content. The computing device can include a display device, a textbook creator, and a transcript editor. The textbook creator can be configured to receive the time-based transcript from the computer system, and to receive the set of time-based thumbnail images. The transcript editor can be configured to modify the time-based transcript to include at least one of the thumbnail images included in the set of time-based thumbnail images in the time-based transcript at a location in the time-based transcript corresponding to a time point on the timeline where the thumbnail image was displayed in at least one frame of the online course on the display device.

Example implementations may include one or more of the following features. For instance, the server can further include a scene transition detector. The thumbnail generator can be further configured to provide the set of time-based thumbnail images to the scene transition detector. The scene transition detector can be configured to identify a scene cut as a time on the timeline where a measurable difference occurs between two consecutive thumbnail images included in the set of time-based thumbnail images, and to generate a subset of the time-based thumbnail images that includes thumbnail images located at identified scene cuts. The subset of the time-based thumbnail images may not include duplicate thumbnail images of frames of images that occur between each scene cut. Receiving the set of time-based thumbnail images by the computing device can include receiving the subset of the time-based thumbnail images. The time-based transcript can include a plurality of words and a plurality of time indicators. Each time indicator included in the plurality of time indicators can be associated with a word from the plurality of words included in the transcript. Each word included in the plurality of words included in the time-based transcript can be associated with at least one of the thumbnail images included in the set of the time-based thumbnail images. The association can be based on at least a partial overlapping of a time frame associated with a thumbnail image and a time frame associated with an occurrence of the word in the transcript. The textbook creator can be further configured to store the modified time-based transcript as a digital textbook. The transcript editor can be further configured to receive a selection of a filler included in the time-based transcript for removal from the time-based transcript, and remove the filler from the time-based transcript, the removing further modifying the time-based transcript. The transcript editor can be further configured to receive input data for including in the time-based transcript, and add the input data to the time-based transcript, the adding further modifying the time-based transcript.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram of an example system that can be used to create a textbook.

FIG. 1B is a diagram showing an example of the flow of audio and visual content included in a video from the course application 138 through a transcript generator module, a scene transition detector module, and a thumbnail generator module.

FIG. 2A is a diagram showing time-based thumbnail images of a video of an online course identifying example scene cuts.

FIG. 2B is a diagram showing a subset of time-based thumbnail images output by a scene transition detector module.

FIG. 3A is a diagram showing an example web browser UI displaying a time-based transcript.

FIG. 3B is a diagram showing an example web browser UI displaying a first thumbnail image and a second thumbnail image in a pop-up window.

FIG. 3C is a diagram showing the example web browser UI where the first thumbnail image is selected.

FIG. 3D is a diagram showing an example web browser UI displaying a textbook that includes the first thumbnail image as selected for inclusion in a transcript.

FIG. 4A is a diagram showing a web browser UI displaying a time-based transcript, where a cursor 140 is placed on, near, or over (in proximity to) a word included in a transcript text box.

FIG. 4B is a diagram showing an example web browser UI displaying a third thumbnail image and a fourth thumbnail image in a pop-up window.

FIG. 5A is a diagram showing an example web browser UI displaying a textbook.

FIG. 5B is a diagram showing an example web browser UI displaying an updated textbook.

FIG. 6 is a flowchart that illustrates a method for creating a textbook.

FIG. 7 is a flowchart that illustrates a method for providing content for inclusion in a textbook.

FIG. 8 shows an example of a computer device and a mobile computer device that can be used to implement the techniques described here.

Like reference symbols in the various drawings indicate like elements.

### DETAILED DESCRIPTION

A user may want to create a textbook (a digital file for use as a textbook) of an online course (an online lecture, an online class). The online course can be a video that includes visual and audio content. The user can access the online course using a web browser executing on a computing device. In a non-limiting example, the computing device can be a laptop computer, a desktop computer, a smartphone, a personal digital assistant, a tablet computer, or a notebook computer. The user can watch the video content on a display device included in the computing device. The user can listen to the audio content on one or more speakers that are included in the computing device.

The provider of the online course can provide the video of the online course and a transcript of the online course. The visual content of the online course can show images of the lecturer along with images of exhibits such as figures, charts, equations, models, and other visual aids used by the lecturer while teaching the online course. The audio content of the online course can include the lecturer speaking about the course content while referring to the exhibits. The transcript can include the text of the audio content (e.g., the text of the words spoken by the lecturer when giving the online course). The transcript, however, may not include any images of the exhibits presented during the online lecture. In addition, the transcript may include fillers that may not contribute to the content of the lecture (e.g., “um”, “uh”, “er”, “uh-huh”, “well”, “like”). The transcript can be synchronized with the visual content of the video of the online course. The synchronization can correlate the words included in the transcript with one or more images included in the visual content.

The user can obtain a copy of the transcript from the provider of the online course. The provider of the online course can provide the copy of the transcript in the form of a digital file that the user can edit. The user can begin the creation of a textbook starting with the digital file of the provided transcript. The user can edit the transcript. The editing can include, but is not limited to, removing (deleting) the unnecessary fillers and adding notes or other input data. The user can also edit the transcript to include images of the exhibits shown during the online lecture. The user can add a particular image to the textbook at the point in the transcript that includes the text of the words spoken by the lecturer when describing (explaining, referring to) the particular image.

In some implementations, a user would need to view the visual content of the lecture, take a snapshot (a screenshot) of the particular image while it is displayed on the display device during the course of the display of the visual content of the online lecture, and then insert the snapshot (screenshot) of the particular image into the digital file of the provided transcript at the point in the transcript that includes the text of the words spoken by the lecturer when describing (explaining, referring to) the particular image. This can be a complicated, cumbersome process.

In some implementations, while a user is editing the transcript, the user can hover over the text included in the transcript. For example, the user can hover over the text by passing a cursor over the text of the transcript that is displayed on a display device included in a computing device. The cursor is also displayed on the display device. The user can control the location (placement) and movement of the cursor using one or more input devices included on or with the computing device. The input devices can include, but are not limited to, a mouse, a trackpad, a touchpad, a touchscreen, a keypad, a pointer stick, a mouse button, a keyboard, a trackball, and a joystick. While hovering over and along the displayed text of the transcript, thumbnails of an image that was included in the visual content of the online course while the words represented by the text were spoken and included in the audio content of the online course are displayed. The user can pause movement of the cursor while hovering over the displayed text of the transcript, stopping near or over a particular portion of the text (e.g., a word or words). The user can select a displayed thumbnail image of interest by moving the cursor over the image of the thumbnail, and performing an operation with the input device (e.g., pressing a button, tapping a finger) that can be interpreted by the computing device as a “click’ that selects the image. The selected image can be included in the transcript at (or near) a particular portion of the text. The user can proceed through the transcript, selecting and including images in the transcript at selected locations in the text of the transcript, creating a textbook. In addition, the user can edit (remove) fillers from the transcript. The user can add notes at any location in the text of the transcript. The result can be a textbook (a digital file that can be considered a textbook) based on a transcript of the online course that includes the removal of unnecessary words or phrases (e.g., fillers) spoken by the lecturer, and the inclusion of images of the exhibits presented during the online lecture at locations in the transcript that correlate to the presenting of the exhibits during the visual portion of the online lecture. The textbook can also include notes added to the transcript by the user that can enhance and further explain course content included in the audio portion of the online lecture.

For example, a user can take an online course that can include multiple installments. The user can choose to create the textbook after each installment (e.g., a chapter at a time) or after completing the entire online course.

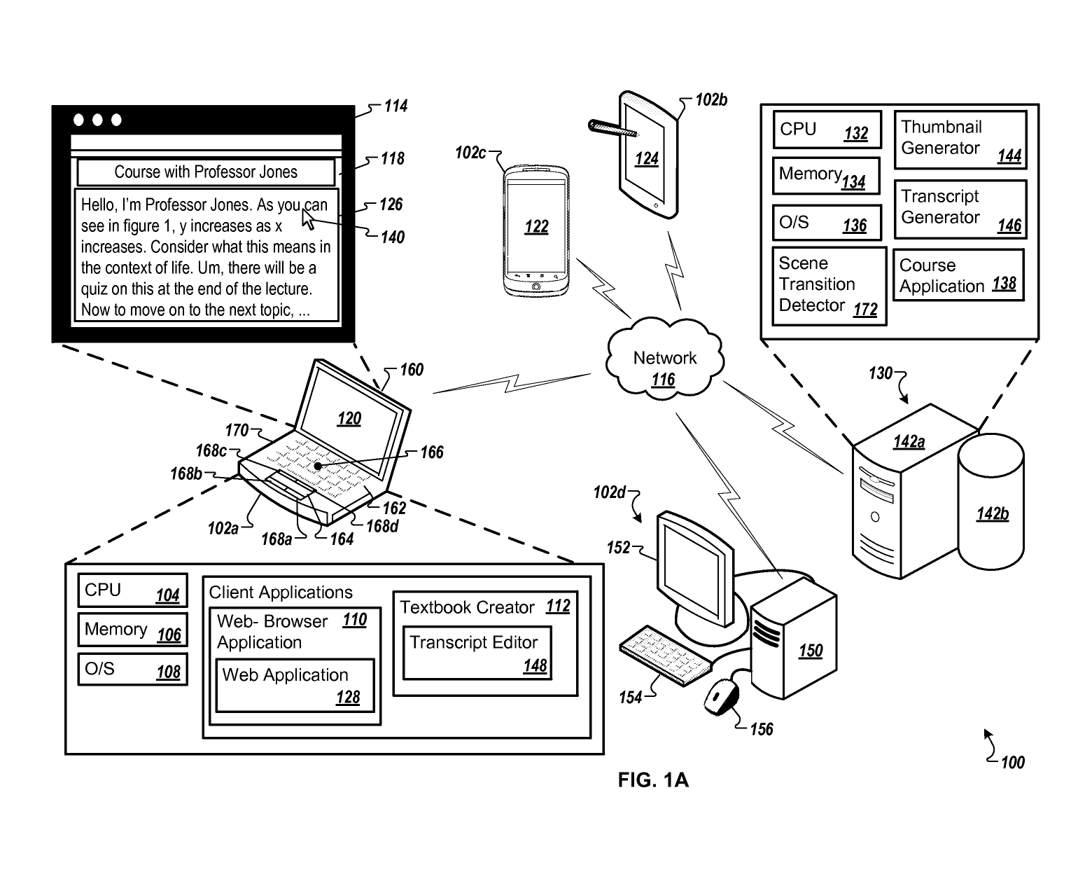

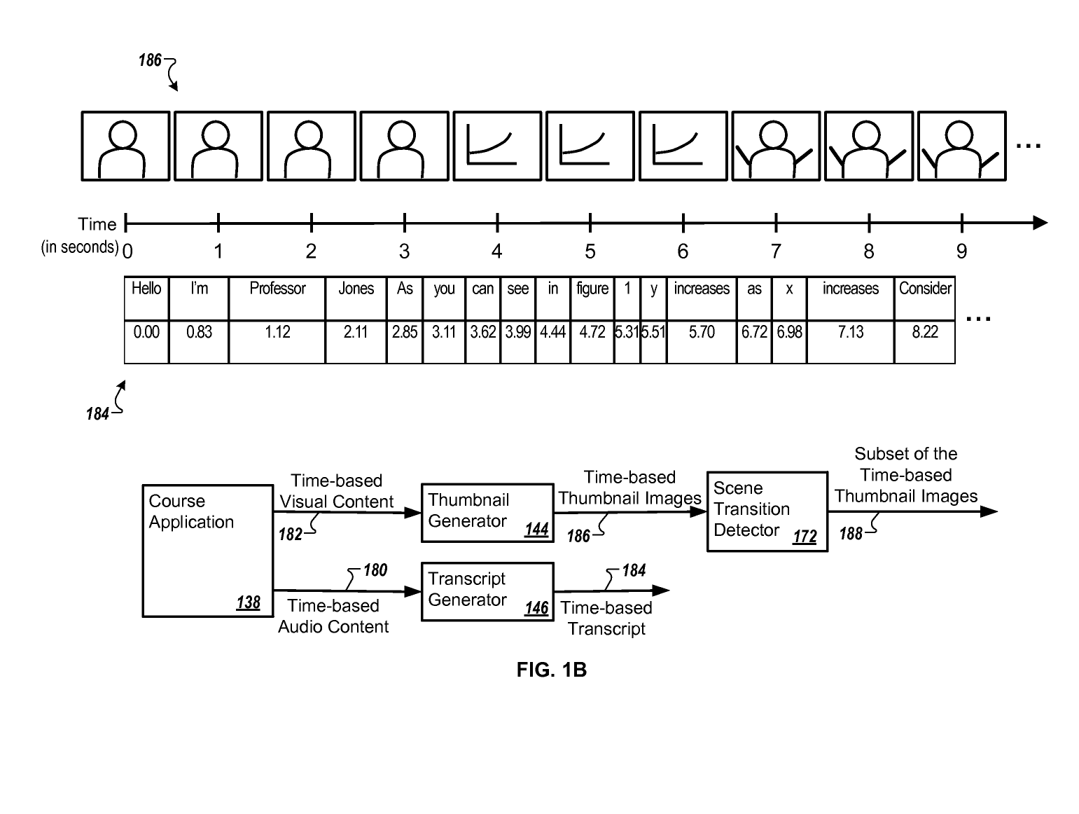

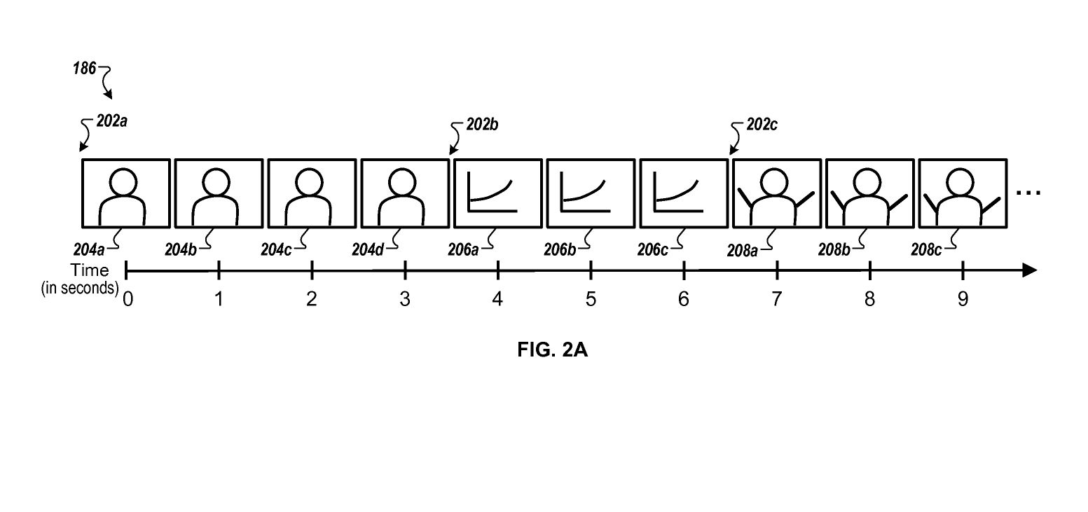

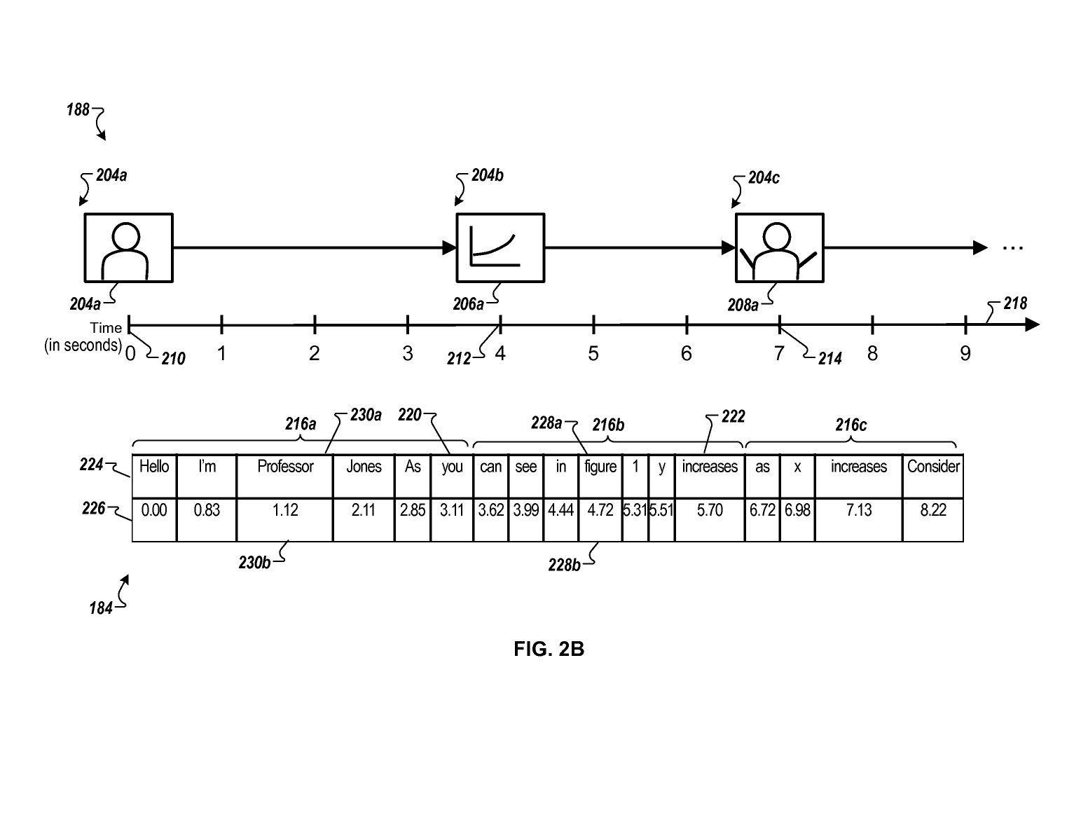

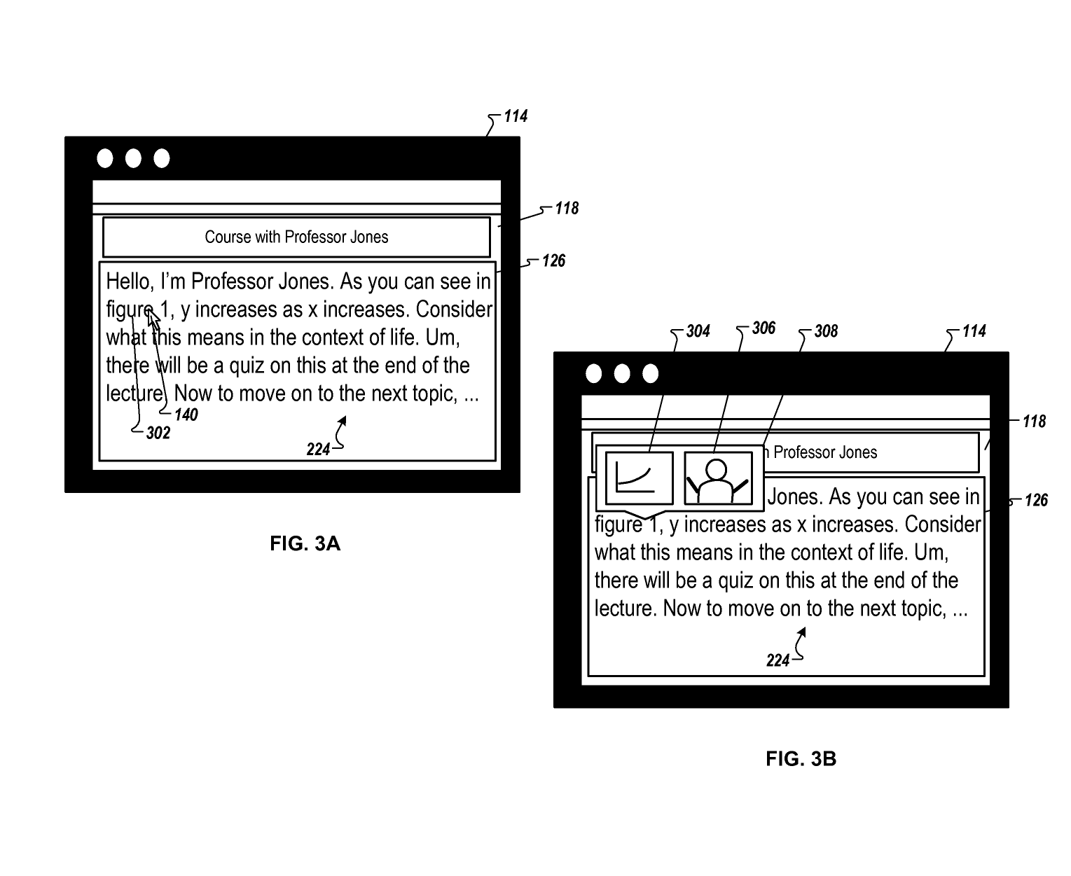

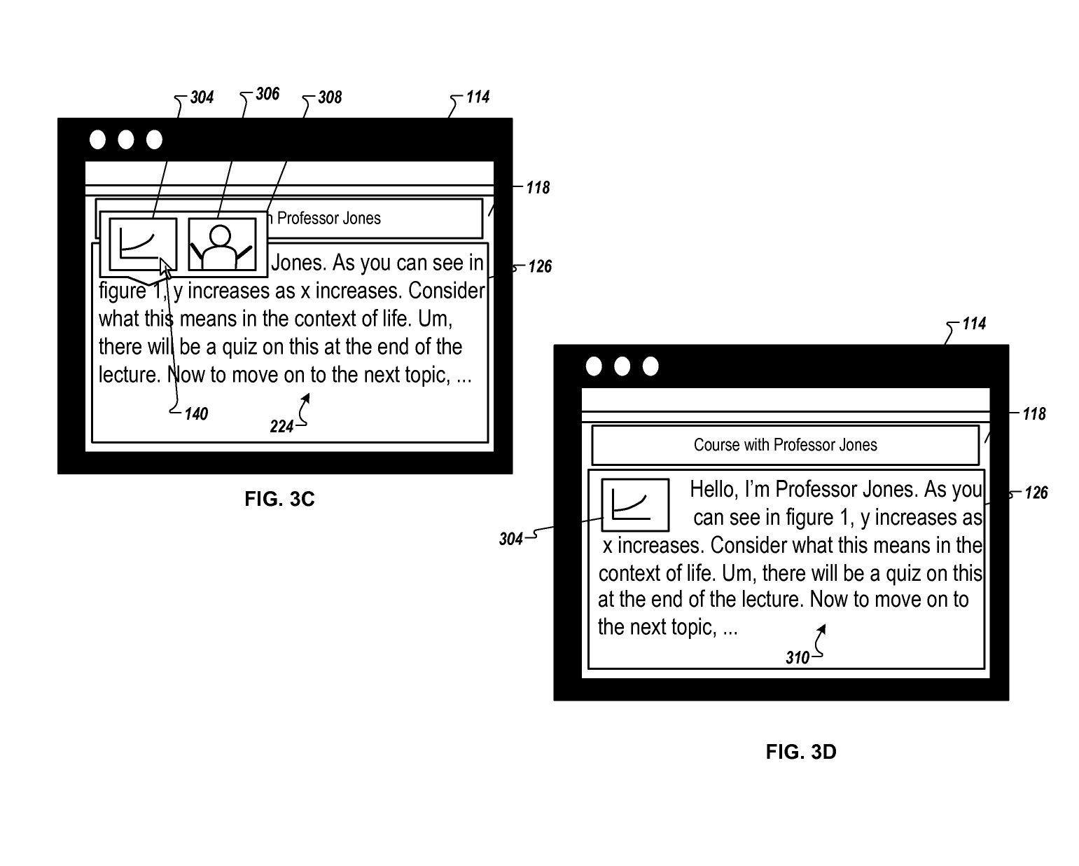

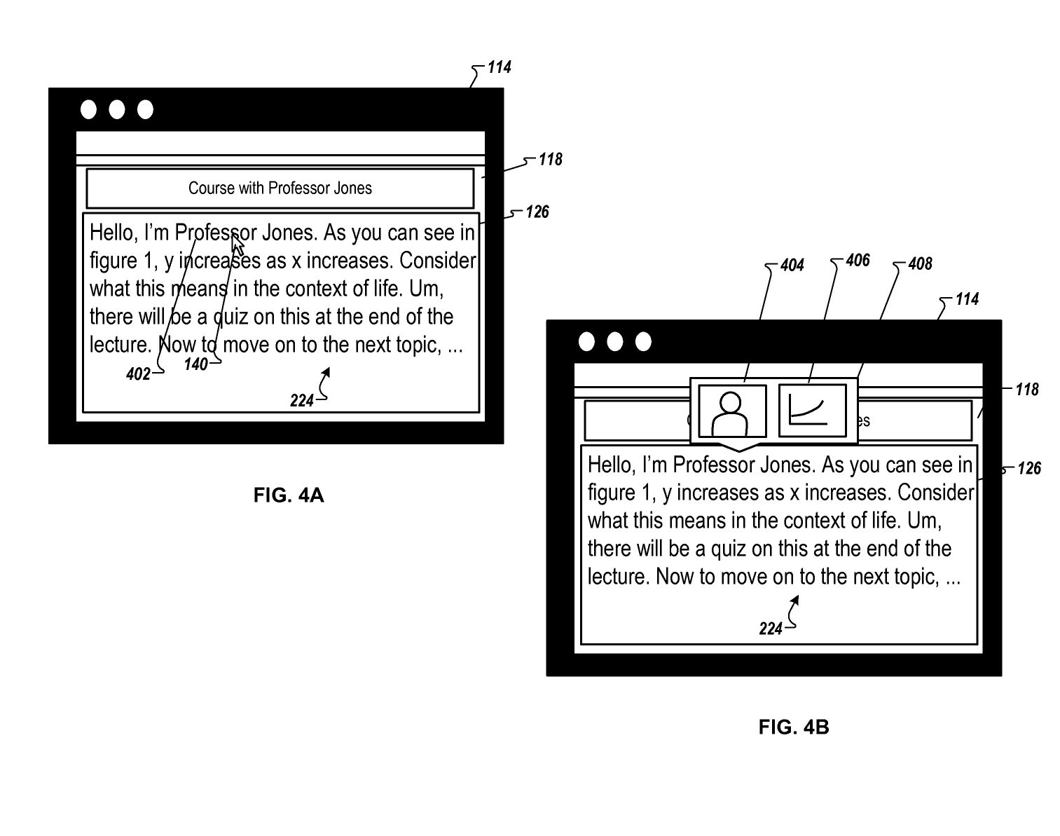

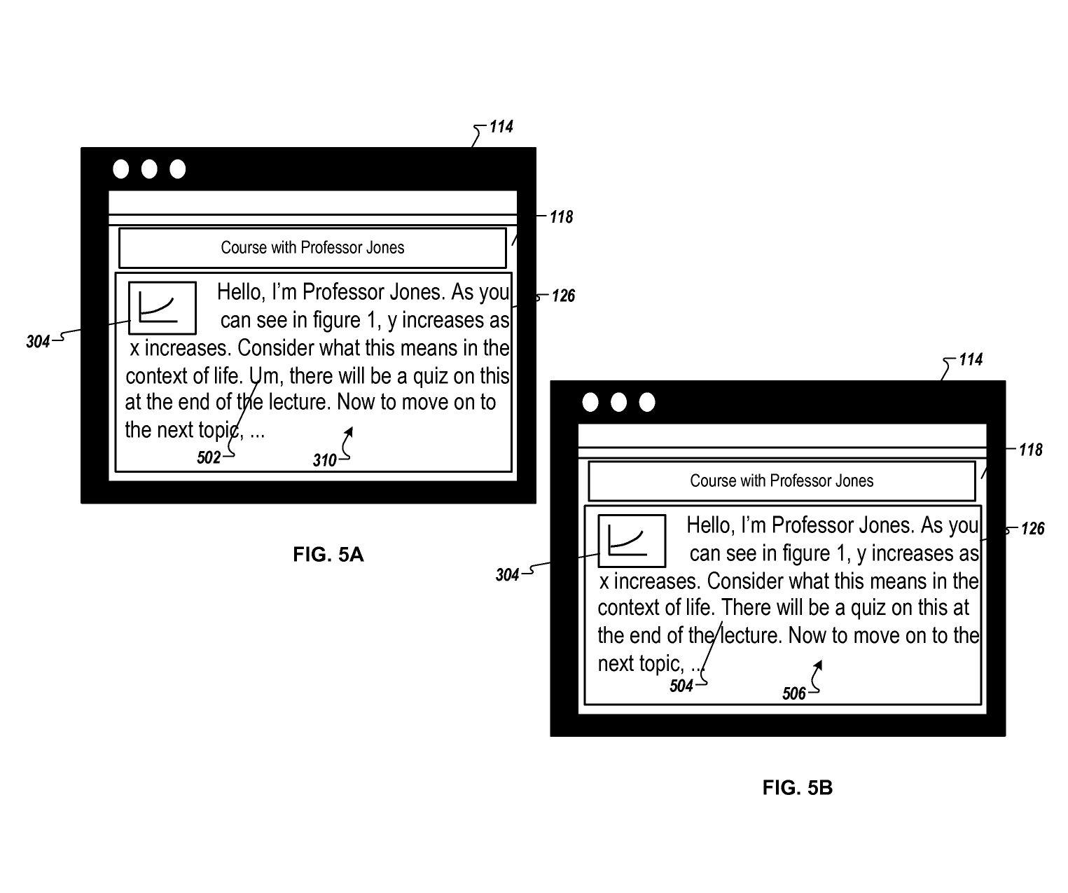

FIG. 1A is a diagram of an example system 100 that can be used to create a textbook. The example system 100 includes a plurality of computing devices 102a-d (e.g., a laptop or notebook computer, a tablet computer, a smartphone, and a desktop computer, respectively). An example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110 and a textbook creator application (e.g., a textbook creator 112). In some implementations, as shown in the example system 100, the textbook creator 112 can be an application included with other client applications that the computing device 102a can execute. In some implementations, the textbook creator 112 can be included in (be part of) the web application 128. The web browser application 110 can display a user interface (UI) (e.g., a web browser UI 114) on a display device 120 included in the computing device 102a.

The system 100 includes a computer system 130 that can include one or more computing devices (e.g., a server 142a) and one or more computer-readable storage devices (e.g., a database 142b). The server 142a can include one or more processors (e.g., a server CPU 132), and one or more memory devices (e.g., a server memory 134). The computing devices 102a-d can communicate with the computer system 130 (and the computer system 130 can communicate with the computing devices 102a-d) using a network 116. The server 142a can execute a server O/S 136. The server 142a can provide online course videos that can be included in (stored in) the database 142b, where the database 142b can be considered an online course repository. The server 142a can execute a course application 138 that can provide a video of an online course to the computing devices 102a-d using the network 116.

In some implementations, the computing devices 102a-d can be laptop or desktop computers, smartphones, personal digital assistants, tablet computers, or other appropriate computing devices that can communicate, using the network 116, with other computing devices or computer systems. In some implementations, the computing devices 102a-d can perform client-side operations, as discussed in further detail herein. Implementations and functions of the system 100 described herein with reference to computing device 102a, may also be applied to computing device 102b, computing device 102c, and computing device 102d and other computing devices not shown in FIG. 1 that may also be included in the system 100.

The computing device 102a includes the display device 120 included in a lid portion 160 and one or more input devices included in a base portion 170. The one or more input devices include a keyboard 162, a trackpad 164, a pointer button 166, and mouse buttons 168a-d. A user can interact with one or more of the input devices to hover over text included in the transcript displayed on the display device 120. The user can interact with one or more of the input devices to select thumbnails for inclusion in the transcript when creating a textbook. In some implementations, the display device 120 can be a touchscreen. The user can also interact with the touchscreen to hover over text included in the transcript displayed on the display device 120 and to select thumbnails for inclusion in the transcript when creating a textbook.

In some implementations, the computing device 102a can store the textbook in the memory 106. A user can access the memory 106 to view and edit the textbook using the textbook creator 112 and the transcript editor 148. In some implementations, the computing device 102a can send the textbook (can send a copy of the textbook) to the computer system 130. In some implementations, the computer system 130 can store the textbook in the memory 134. In some implementations, the computer system 130 can store the textbook in the database 142b. When storing the textbook on the computer system 130, the computer system 130 (and in some cases the user) can identify permissions to associate with the textbook. For example, the textbook may be accessible by a wide range of users (e.g., users who are taking the same online course, users who are enrolled in the same provider of the online course). For example, in some cases, the textbook may be accessible by the wide range of users who may have both read and write (edit) permissions. For example, in some cases, the textbook may be accessible by the wide range of users who may have only have read access and the author or creator of the textbook may be the only individual with edit or write access. In another example, though the textbook is stored on the computer system 130, the author or creator of the textbook may be the only individual who can access the textbook.

The computing device 102b includes a display area 124 that can be a touchscreen. The computing device 102c includes a display area 122 that can be a touchscreen. The computing device 102d can be a desktop computer system that includes a desktop computer 150, a display device 152 that can be a touchscreen, a keyboard 154, and a pointing device (e.g., a mouse 156). A user can interact with one or more input devices and/or a touchscreen to hover over text included in a transcript displayed on a display device and to select thumbnails for inclusion in the transcript when creating a textbook.

In some implementations, the computer system 130 can represent more than one computing device working together to perform server-side operations. For example, though not shown in FIG. 1, the system 100 can include a computer system that includes multiple servers (computing devices) working together to perform server-side operations. In this example, a single proprietor can provide the multiple servers. In some cases, the one or more of the multiple servers can provide other functionalities for the proprietor.

In some implementations, the network 116 can be a public communications network (e.g., the Internet, cellular data network, dialup modems over a telephone network) or a private communications network (e.g., private LAN, leased lines). In some implementations, the computing devices 102a-d can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the web browser application 110 can execute or interpret a web application 128 (e.g., a browser-based application). The web browser application 110 can include a dedicated user interface (e.g., the web browser UI 114). The web application 128 can include code written in a scripting language, such as AJAX, JavaScript, VBScript, ActionScript, or other scripting languages. The web application 128 can display a web page 118 in the web browser UI 114. The web page 118 can include a transcript text box 126 that includes text of a transcript of an online course. A user can hover over the text by placing a cursor 140 on or near (in proximity to) a word included in the transcript text box 126. The user can interact with one or more input devices included in a computing device (e.g., the keyboard 162, the trackpad 164, the pointer button 166, and the mouse buttons 168a-d included in the computing device 102a) and/or a touchscreen included in the computing device to place the cursor (e.g., the cursor 140) at a desired location within a transcript text box (e.g., the transcript text box 126).

The computing device 102a can receive a video of an online video course from the computer system 130. For example, the web application 128 can display in the web browser UI 114 one or more icons representative of (associated with) respective one or more courses for selection by a user of the computing device 102a. For example, the user can select a course by placing a cursor on an icon. The user can then select the icon (e.g., click a mouse button). The selection of the icon can launch the online course. When launched, the computer system 130 can provide the video of the online course. The display device 120 can display the visual content of the video of the online course and one or more speakers (not shown) included in the computing device 102a can play the audio portion of the online course. The course application 138 can retrieve the video of the online course from the database 142b. The server 142a using the network 116 can provide the video to the computing device 102a.

FIG. 1B is a diagram showing an example of the flow of audio and visual content included in a video from the course application 138 through a transcript generator module (e.g., a transcript generator 146), a scene transition detector module (e.g., the scene transition detector 172), and a thumbnail generator module (e.g., a thumbnail generator 144) included in the server 142a. The course application 138 can provide a time-based version of the audio content (e.g., time-based visual content 182) of a video of an online course to the transcript generator 146. The course application 138 can provide a time-based version of the visual content (e.g., time-based visual content 182) of a video of an online course to the thumbnail generator 144. The thumbnail generator 144 generates a time-based version of a set of thumbnail images (e.g., time-based thumbnail images 186). The transcript generator 146 generates a time-based version of the words spoken during the online course in a time-based version of a transcript (e.g., time-based transcript 184). The scene transition detector 172 generates a time-based version of a subset of the time-based thumbnail images 186 (e.g., time-based thumbnail image subset 188) based on one or more criteria.

Referring to FIG. 1A, the server 142a (and specifically the course application 138) can provide the time-based thumbnail image subset 188 and the time-based transcript 184 to the computing device 102a using the network 116. The textbook creator 112 can receive the time-based thumbnail image subset 188 and the time-based transcript 184. A transcript editor 148 included in the textbook creator 112 can display the time-based transcript 184 in the transcript text box 126. As a user hovers over the text included in the transcript text box 126, the time-based thumbnail image subset 188 can be coordinated with (synchronized with) the text included in the time-based transcript 184.

Each word included in the time-based transcript 184 can be associated with a thumbnail image included in the time-based thumbnail images 186 as shown in FIG. 1B. Including the time base for both the audio content and the visual content of the video of the online course allows the synchronization of the audio content with the visual content while allowing each portion of the video content to be processed separately (e.g., the thumbnail generator 144 can process the time-based visual content 182 and the transcript generator 146 can process the time-based audio content 180).

FIG. 2A is a diagram showing the time-based thumbnail images 186 of a video of an online course identifying example scene cuts 202a-c. For example, referring to FIGS. 1A-B, the time-based thumbnail images 186 are input to (provided to) the scene transition detector 172. The scene transition detector 172 can analyze each frame (frames 204a-d, frames 206a-c, and frames 208a-c) included in the time-based thumbnail images 186 to determine when scene changes or transitions occur in the time-based thumbnail images 186 of the video of the online course. The scene transition detector 172 can filter out like frames until a scene transition is detected.

A frame can include an image of a scene at a particular point in time. For example, the scene transition detector 172 can identify a first scene cut 202a at a time=zero seconds (time 210). The frames 204a-d can include respective images of the same scene. Though shown as the same image in FIG. 2A, the frames 204a-d may not be the same image. The frames 204a-d can each be an image of the same scene. For example, even if the lecturer is essentially standing or sitting in the same position while lecturing for a particular period of time, each image (or frame) may be slightly different if the position of the lecturer moves slightly within the captured image space.

In the example shown in FIGS. 1B and 1n FIG. 2A, the time-based thumbnail images 186 show a frame occurring every second (a frame rate of one frame per second). In some implementations, a frame rate for the video of the online course can be greater than the one frame per second frame rate. For example, a frame can occur every 1/60^{th} of a second (a frame rate of 60 frames per second). In some implementations, the thumbnail generator 144 can subsample the time-based visual content 182 to generate the time-based thumbnail images 186. In some implementations, the thumbnail generator 144 can provide the time-based thumbnail images 186 at the same frame rate as that of the time-based visual content 182.

In some implementations, the scene transition detector 172 can identify scene cuts by comparing a histogram of one image included in a frame to another image included in a next frame for consecutive frames. The scene transition detector 172 can set a threshold value for the comparison such that if a difference between the histograms of each image is equal to or above a threshold value, the scene transition detector 172 can determine that a scene change occurred from one frame to the next frame. The scene transition detector 172 can identify a scene cut as being between the two consecutive frames. As shown in FIG. 2A, the scene transition detector 172 can identify a second scene cut 202b, where frame 202b and frame 206a include different images. In addition, the scene transition detector 172 can identify a third scene cut 202c, where frame 206c and frame 208a include different images.

FIG. 2B is a diagram showing a subset of the time-based thumbnail images 186 (e.g., the time-based thumbnail image subset 188) output by a scene transition detector module (e.g., the scene transition detector 172). The time-based thumbnail image subset 188 is shown with respect to a timeline 218. The time-based thumbnail images 188 are a subset of the time-based thumbnail images 186. FIG. 2B also shows the time-based transcript 184 with respect to the timeline 218. The time-based thumbnail image subset 188 include frames 204a, 206a, and 208a. Because of the similarity of many of the frames included in the time-based visual content 182, the time-based thumbnail image subset 188 can include a single frame (or image) at each identified scene cut 202a-c. In the example time-based thumbnail image subset 188, the frame 204a is provided as a time-based thumbnail image associated with words 216a that were spoken during a time from time 210 (zero seconds) to a time equal to approximately four seconds (time 212). The frame 206a is provided as a time-based thumbnail image associated with words 216b that were spoken during a time from time 212 (four seconds) to a time equal to approximately eight seconds (time 214). The frame 208a is provided as a time-based thumbnail image associated with words 216c that were spoken during a time starting at time 214 (approximately eight seconds).

FIG. 2B also shows the time-based transcript 184 as a transcript 224 with a per-word time key 226. The transcript 224 includes the words 216a-c. As shown in FIG. 2B, there can be words included in the transcript 224 at positions (e.g., position 220, position 222) in the time key 226 that can straddle a scene cut. In these cases, the transcript editor 148 can associate the frame provided as a time-based thumbnail image with the word based on the time associated with the start of the spoken word.

For example, referring to FIG. 1A, the textbook creator 112 can receive the time-based thumbnail image subset 188 and the time-based transcript 184 from the server 142a. A transcript editor 148 included in the textbook creator 112 can display the time-based transcript 184 in the transcript text box 126. As a user hovers over the text included in the transcript text box 126 and moves the cursor 140, the time-based thumbnail image subset 188 can be coordinated with (synchronized with) the text included in the time-based transcript 184.

FIG. 3A is a diagram showing an example web browser UI (e.g., the web browser UI 114) displaying the time-based transcript 224. Referring to FIG. 1A and FIG. 2B, a computing device (e.g., the computing device 102a) can display the text (words 216a-c) of the time-based transcript 224 in the transcript text box 126 included in the web page 118. The textbook creator 112 can display the text (words 216a-c) of the time-based transcript 224 in the transcript text box 126. A user can interact with the transcript editor 148 to select images for inclusion in the transcript 224 and to edit the transcript 224 in order to create a textbook (e.g., textbook 310 as shown in FIG. 3D). A user can hover over the text by placing the cursor 140 on, near, or over (in proximity to) a word included in the transcript text box 126. The user can interact with one or more input devices included in the computing device 102a to position (place or hover) the cursor 140 over a word 302 (e.g., the word “figure”).

FIG. 3B is a diagram showing the example web browser UI (e.g., the web browser UI 114) displaying a first thumbnail image 304 and a second thumbnail image 306 in a pop-up window 308. The transcript editor 148 can cause the display of the pop-up window 308 over (superimposed on) the time-based transcript 224 displayed in the transcript text box 126 included in the web page 118. Referring to FIG. 2B, the word 302 is included in the transcript 224 at a position 228a that corresponds to a time window 228b as indicated by the time key 226. The time window 228b is between frame 206a and frame 208a. The first thumbnail image 304 is the image for the frame 206a that is before the position 228a of the word 302 with respect to the time key 226 (the time window 228b). The second thumbnail image 306 is the image for the frame 208a that is after the position 228a of the word 302 with respect to the time key 226 (the time window 228b).

FIG. 3C is a diagram showing the example web browser UI (e.g., the web browser UI 114) where the first thumbnail image 304 is selected. For example, referring to FIG. 1A, a user interacting with one or more input devices (e.g., the input devices included in the computing device 102a) can place the cursor 140 on the first thumbnail image 304 and perform an action with the one or more input devices to select the first thumbnail image 304 for placement in the transcript 224. For example, a user can interact with the trackpad 164 to move (place or position) the cursor 140 on or over the first thumbnail image 304. The user can press (click) the mouse button 168a, selecting the first thumbnail image 304 for inclusion in the transcript 224.

FIG. 3D is a diagram showing the example web browser UI (e.g., the web browser UI 114) displaying a textbook 310 that includes the first thumbnail image 304 as selected by a user for inclusion in the transcript 224.

As a user hovers over the words 216a-c included in the time-based transcript 224, the first thumbnail image 304 and the second thumbnail image 306 can change. For example, FIG. 4A is a diagram showing the web browser UI 114 displaying the time-based transcript 224, where the cursor 140 is placed on, near, or over (in proximity to) a word 402 (e.g., the word “Professor”) included in the transcript text box 126 that is different from the word 302 (e.g., the word “figure”).

FIG. 4B is a diagram showing the example web browser UI (e.g., the web browser UI 114) displaying a third thumbnail image 404 and a fourth thumbnail image 406 in a pop-up window 408. In a manner similar to that described with reference to FIG. 3B, the pop-up window 408 can be displayed over (superimposed on) the time-based transcript 224 displayed in the transcript text box 126 included in the web page 118. Referring to FIG. 2B, the word 402 is included in the transcript 224 at a position 230a that corresponds to a time window 230b as indicated by the time key 226. The time window 230b is between frame 204a and frame 206a. The third thumbnail image 404 is the image for the frame 204a that is before the position 230a of the word 402 with respect to the time key 226 (the time window 230b). The fourth thumbnail image 406 is the image for the frame 206a that is after the position 230a of the word 402 with respect to the time key 226 (the time window 230b).

In a manner similar to that described with reference to FIGS. 3C-D, a user can select the fourth thumbnail image 406 to include in the transcript 224 when creating a textbook.

FIG. 5A is a diagram showing the example web browser UI (e.g., the web browser UI 114) displaying a textbook (e.g., the textbook 310 as shown in FIG. 3D). As described with reference to FIGS. 3A-D, a user interacting with the transcript 224 can select a thumbnail image (e.g., the first thumbnail image 304) to include in a textbook (e.g., the textbook 310). Referring to FIG. 1A and FIGS. 3A-D, a user interacting with the transcript editor 148 included in the computing device 102a can edit the transcript 224 (can edit the textbook 310 that is based on (includes) the transcript 224) to remove any fillers (e.g., filler 502 (the filler “um”)) that may not contribute to the content of the lecture.

FIG. 5B is a diagram showing the example web browser UI (e.g., the web browser UI 114) displaying an updated textbook (e.g., updated textbook 506, which is an update of the textbook 310 as shown in FIG. 3D). As shown in general by reference designator 504, the updated textbook 506 no longer includes the filler 502. In addition, the user edited the word “there” to have a capital “T” as it is not the beginning of a sentence.

Referring to FIGS. 1A-B, the thumbnail generator 144, the transcript generator 146, and the scene transition detector 172 are included in the server 142a. In this implementation, the server 142a provides (sends) the time-based thumbnail image subset 188 output from the scene transition detector 172 and the time-based transcript 184 output from the transcript generator 146 to the textbook creator 112 included in the computing device 102a by way of the network 116.

In some implementations, the thumbnail generator 144, the transcript generator 146, and the scene transition detector 172 can be included in the computing device 102a (e.g., in the textbook creator 112). In these implementations, the computer system 130 (and specifically the course application 138) can provide (send) a video of an online video course to the computing device 102a as it would if the computing device 102a were displaying the video on the display device 120 for viewing by a user. In these implementations, for example, if a user has launched the textbook creator 112, the textbook creator 112 can request the video of the online course. When received, the thumbnail generator 144, the transcript generator 146, and the scene transition detector 172 can perform the functions as described herein.

In some implementations, the thumbnail generator 144, the transcript generator 146, and the scene transition detector 172 can be included in either the computing device 102a or the server 142a. For example, in one such implementation, the thumbnail generator 144 and the transcript generator 146 can be included in the server 142a and the scene transition detector 172 can be included in the computing device 102a (e.g., in the textbook creator 112). In these implementations, the server 142a can provide the time-based thumbnail images 186 generated by the thumbnail generator 144 to the scene transition detector 172 included in the textbook creator 112 included in the computing device 102a by way of the network 116. The server 142a can provide the transcript 224 generated by the transcript generator 146 to the textbook creator 112 included in the computing device 102a by way of the network 116.

In some implementations, the textbook can be created in a collaborative manner. For example, referring to FIG. 5B, a user can upload the textbook 506 to a web site that can be access by other users participating in the same online course. Each user can edit the textbook 506 providing a comprehensive resource for use by individuals participating in (or interested in participating in) the online course.

In some implementations, the server 142a can include a textbook creator module that can automate the generating (creating) of a textbook. In these implementations, the time-based thumbnail image subset 188 and the time-based transcript 184 can be input to the textbook creator module. The textbook creator module can parse the text included in the time-based transcript 184 to determine locations within the text associated with scene transitions. The textbook creator module can perform image analysis on the images included in the time-based thumbnail image subset 188 to determine the images that include image data related to the lecturer (e.g., a head shot of the lecturer). Based on the information provided by the image analysis and on the determined locations within the text associated with scene transitions, the textbook creator module can identify exhibits included in the images by eliminating those images that include information for the lecturer. The textbook creator module can identify the exhibits for inclusion in the time-based transcript 184 when creating (generating) a textbook.

In addition, the textbook creator module can parse the text included in the time-based transcript 184 to identify fillers (e.g., “um”, “uh”, “er”, “uh-huh”, “well”, “like”). The textbook creator module can remove the identified fillers. The textbook creator module can also parse the text and automatically correct spelling and, in some cases, grammatical errors in the time-based transcript 224.

Though described in the context of an online course, lecture or class, the systems, processes and techniques described herein can be applied to any video that includes visual and audio content where a transcript of the audio content, synchronized to the visual content, is made available to a user in the form of a digital file that can be provided to a computing device for editing by the user.

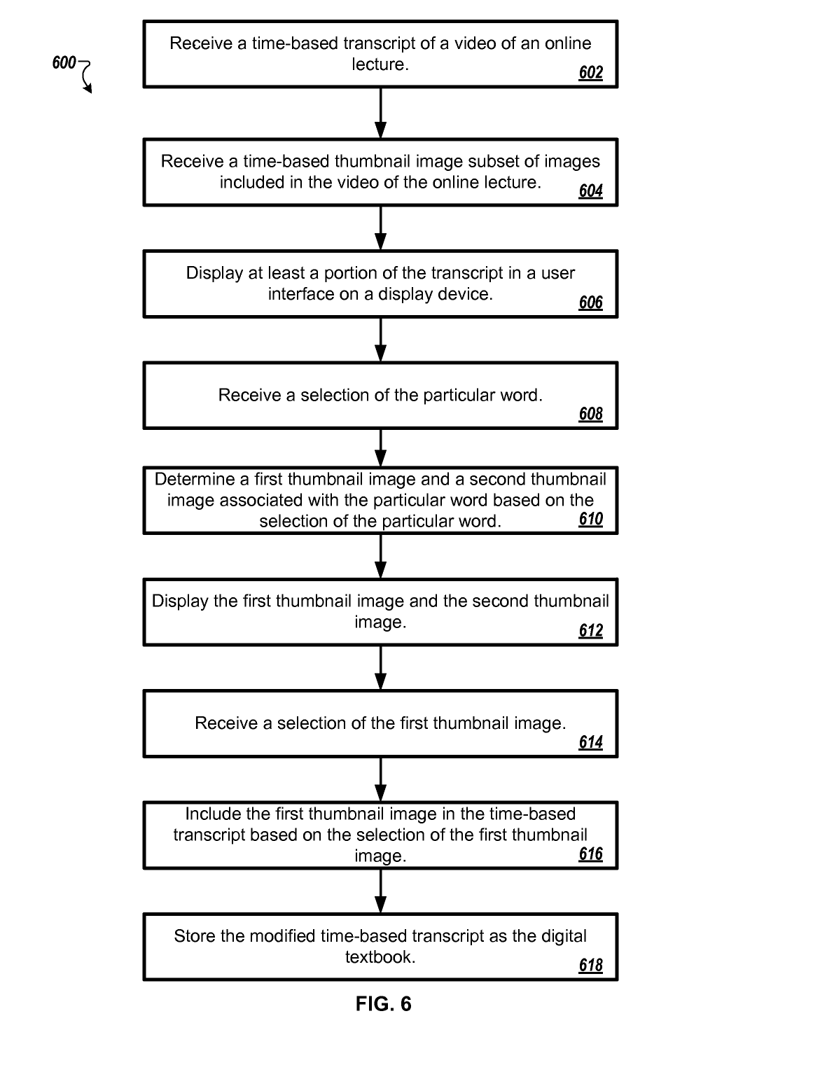

FIG. 6 is a flowchart that illustrates a method 600 for creating (generating) a textbook. In some implementations, the systems described herein can implement the method 600. For example, the method 600 can be described referring to FIGS. 1A-B, 2A-B, 3A-D, 4A-B and 5A-B.

A time-based transcript of a video of an online lecture is received by a computing device (block 602). Referring to FIGS. 1A-B, the time-based transcript (e.g., the time-based transcript 184) can include a plurality of words (e.g., the words 216a-c) and a plurality of time indicators (e.g., the per-word time key 226). Each time indicator included in the plurality of time indicators can be associated with a word from the plurality of words included in the transcript as shown, in particular, in FIG. 2B.

A time-based thumbnail image subset of images included in the video of the online lecture is received by the computing device (block 604). The time-based thumbnail image subset (e.g., the time-based thumbnail image subset 188) can include a plurality of thumbnail images (e.g., the frame 204a, the frame 206a and the frame 208a), each of the plurality of thumbnail images being associated with a respective time frame (e.g., the time 210, the time 212, and the time 214, respectively).

At least a portion of the transcript can be displayed in a user interface on a display device included in the computing device (block 606). The portion of the transcript can include a particular word. For example, referring to FIG. 3A, the portion of the transcript 224 can be displayed in the web browser UI 114. The portion of the transcript 224 includes the word 302.

A selection of the particular word can be received from the user interface (block 608). For example, a user can place a cursor 140 over the word 302 and interact with an input device to select the word 302.

A first thumbnail image and a second thumbnail image associated with the particular word can be determined based on the selection of the particular word (block 610). The first thumbnail image and the second thumbnail image can be included in the plurality of thumbnail images. The first thumbnail image and the second thumbnail image can be displayed in the user interface (block 612). For example, referring to FIG. 2B, the first thumbnail image and the second thumbnail image can be determined based on the position of the word 302 in the time key 226. Referring to FIG. 3B, the web browser UI 114 can display the first thumbnail image 304 and the second thumbnail image 306 in the pop-up window 308. A selection of the first thumbnail image is received from the user interface (block 614). For example, referring to FIG. 3C, a user interacting with one or more input devices included in the computing device 102a can place the cursor 140 on the first thumbnail image 304 and perform an action with the one or more input devices to select the first thumbnail image 304 for placement in the transcript 224.

The first thumbnail image is included in the time-based transcript based on the selection of the first thumbnail image (block 616). The including modifies the time-based transcript. For example, referring to FIG. 3D, the web browser UI 114 displays a textbook 310 that includes the first thumbnail image 304 as selected by a user for inclusion in the transcript 224. The modified time-based transcript can be stored as the digital textbook (block 618). For example, the textbook creator 112 can store the textbook 310 in the memory 106 included on the computing device 102a.

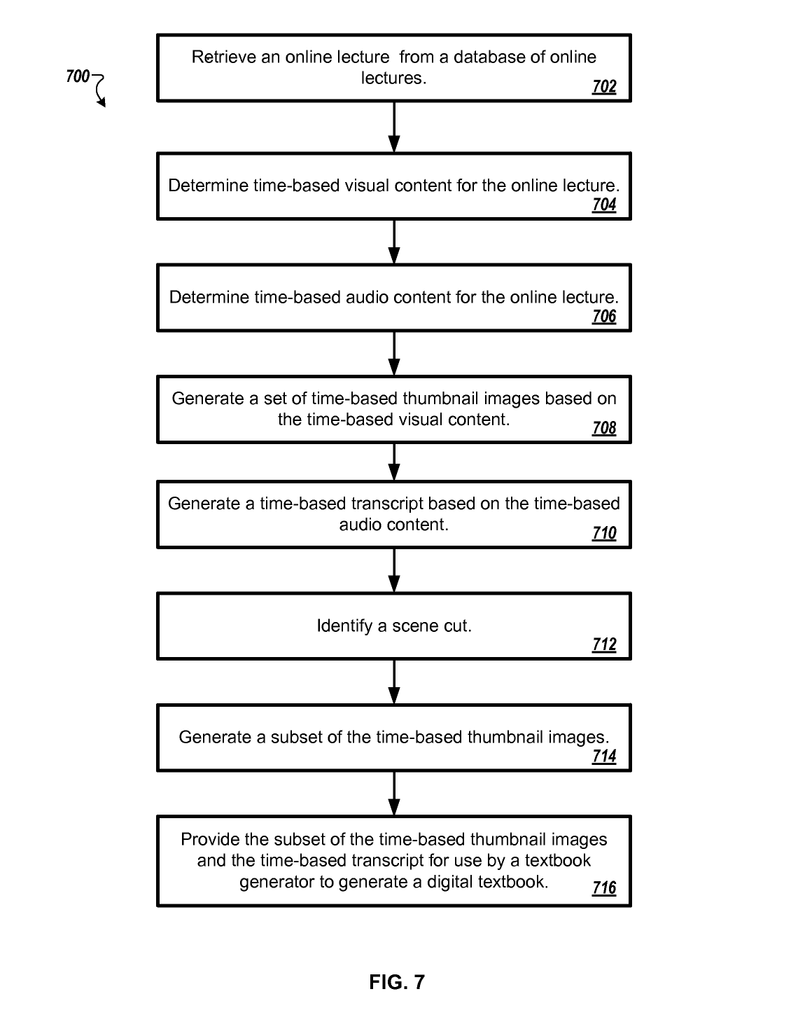

FIG. 7 is a flowchart that illustrates a method 700 for providing content for inclusion in a textbook. In some implementations, the systems described herein can implement the method 700. For example, the method 600 can be described referring to FIGS. 1A-B, 2A-B, 3A-D, 4A-B and 5A-B.

An online lecture is retrieved from a database of online lectures (block 702). For example, referring to FIG. 1A, the course application can retrieve an online lecture from the database 142b. Time-based visual content for the online lecture is determined (block 704). The time-based visual content can include including frames of images. For example, referring to FIG. 1B, the course application can determine the time-based visual content 182. The time-based audio content for the online lecture can be determined (block 706). For example, referring to FIG. 1B, the course application can determine the time-based audio content 180. A set of time-based thumbnail images based on the time-based visual content can be generated (block 708). For example, referring to FIGS. 1A-B, the thumbnail generator 144 can generate the time-based thumbnail images 186. A time-based transcript can be generated based on the time-based audio content (block 710). For example, referring to FIGS. 1A-B, the transcript generator 146 can generate the time-based transcript 184. The time-based thumbnail images and the time-based audio content can be synchronized with a timeline as shown, for example, in FIG. 1B.

A scene cut is identified (block 712). The scene cut can be identified as a time on the timeline where a measurable difference occurs between two consecutive thumbnail images included in the set of time-based thumbnail images. For example, referring to FIG. 2B, the scene transition detector 172 can identify a scene cut as a change or difference between two consecutive frames of the online lecture that differ beyond a particular threshold value.

A subset of the time-based thumbnail images is generated (block 714). Referring to FIG. 2B, the subset of the time-based thumbnail images can include thumbnail images located at identified scene cuts (e.g., frame 204a, frame 206a, and frame 208a). The subset of the time-based thumbnail images may not include duplicate thumbnail images of frames of images that occur between scene cuts. For example, frames 204b-d can be considered duplicates of the frame 204a. Frames 206b-c can be considered duplicates of the frame 206a. Frames 208b-c can be considered duplicates of the frame 208a. Frames 204b-d, frames 206b-c, and frames 208b-c are not included in the subset of the time-based thumbnail images 188.

The subset of the time-based thumbnail images 188 and the time-based transcript 184 is provided for use by a textbook generator to generate a digital textbook (block 716). For example, referring to FIG. 1A, the computer system 130 can provide the subset of the time-based thumbnail images 188 and the time-based transcript 184 to the computing device 102a.

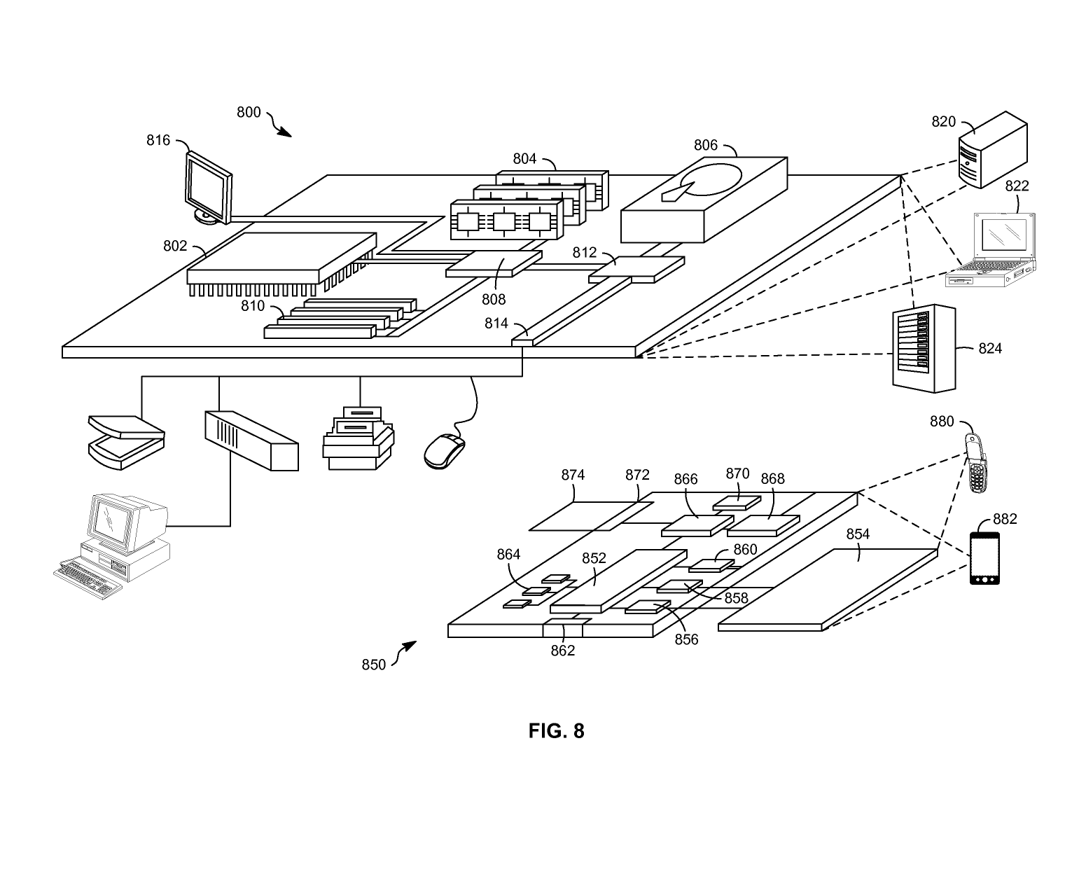

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method for generating a digital textbook, the method comprising:
receiving, by a computing device, a time-based transcript of a video of an online lecture, the transcript including a plurality of words and a plurality of time indicators, each time indicator included in the plurality of time indicators being associated with a word from the plurality of words included in the transcript;
receiving, by the computing device, a time-based thumbnail image subset of images included in the video of the online lecture, the time-based thumbnail image subset including a plurality of thumbnail images, each of the plurality of thumbnail images being associated with a respective time frame;
displaying, in a user interface on a display device included in the computing device, at least a portion of the transcript, the portion of the transcript including a particular word;
receiving, from the user interface, a selection of the particular word;
determining, based on the selection of the particular word, a first thumbnail image and a second thumbnail image associated with the particular word, the first thumbnail image and the second thumbnail image included in the plurality of thumbnail images;
displaying, in the user interface, the first thumbnail image and the second thumbnail image;
receiving, from the user interface, a selection of the first thumbnail image; and
based on the selection of the first thumbnail image, modifying the time-based transcript by including the first thumbnail image in the time-based transcript; and
storing the modified time-based transcript as the digital textbook.

2. The method of claim 1, wherein each time indicator included in the plurality of time indicators indicates a time frame during which the associated word is spoken during the online lecture.

3. The method of claim 1, wherein each respective time frame indicates a time frame during which the associated thumbnail image is displayed on the display device.

4. The method of claim 1, wherein a number of thumbnail images included in the time-based thumbnail image subset is less than a number of thumbnail images identified as included in the video of the online lecture.

5. The method of claim 4, wherein the number of thumbnail images included in the time-based thumbnail image subset is based on determining scene transitions in a visual content of the video of the online lecture.

6. The method of claim 1, wherein determining a first thumbnail image associated with the particular word and a second thumbnail image associated with the particular word comprises:
determining that a time frame associated with the first thumbnail image occurs at least in part before a time indictor associated with the particular word; and
determining that a time frame associated with the second thumbnail image occurs at least in part after the time indictor associated with the particular word.

7. The method of claim 1, further comprising:
receiving, from the user interface, a selection of a filler included in the time-based transcript for removal from the time-based transcript; and
removing the filler from the time-based transcript, the removing further modifying the time-based transcript.

8. The method of claim 1, further comprising:
receiving, from the user interface, input data for including in the time-based transcript; and
adding the input data to the time-based transcript, the adding further modifying the time-based transcript.

9. A method comprising:
retrieving an online lecture from a database of online lectures;
determining time-based visual content for the online lecture, the time-based visual content including frames of images;
determining time-based audio content for the online lecture;
generating a set of time-based thumbnail images based on the time-based visual content;
generating a time-based transcript based on the time-based audio content, the time-based thumbnail images and the time-based audio content being synchronized with a timeline;
identifying a scene cut as a time on the timeline where a measurable difference occurs between two consecutive thumbnail images included in the set of time-based thumbnail images;
generating a subset of the time-based thumbnail images that includes thumbnail images located at identified scene cuts, the subset of the time-based thumbnail images not including duplicate thumbnail images of frames of images that occur between scene cuts; and
providing the subset of the time-based thumbnail images and the time-based transcript for use by a textbook generator to generate a digital textbook.

10. The method of claim 9, wherein the time-based transcript includes a plurality of words and a plurality of time indicators, each time indicator included in the plurality of time indicators being associated with a word from the plurality of words included in the transcript.

11. The method of claim 10, wherein each word included in the plurality of words included in the time-based transcript is associated with at least one of the thumbnail images included in the subset of the time-based thumbnail images, the association based on at least a partial overlapping of a time frame associated with a thumbnail image and a time frame associated with an occurrence of the word in the transcript.

12. A system comprising:
a computer system including:
a database including a plurality of videos of online courses; and
a server including a course application, a transcript generator, and a thumbnail generator, the course application configured to:
retrieve a video of an online course from the plurality of videos of online courses included in the database;
identify a time-based visual content and a time-based audio content of the video of the online course, the identifying based on using a timeline;
provide the time-based audio content to the transcript generator, the transcript generator configured to generate a time-based transcript based on the time-based audio content; and
provide the time-based visual content to the thumbnail generator, the thumbnail generator configured to generate a set of time-based thumbnail images based on the time-based visual content; and
a computing device including:
a display device;
a textbook creator configured to:
receive the time-based transcript from the computer system; and
receive the set of time-based thumbnail images; and
a transcript editor configured to:
modify the time-based transcript to include at least one of the thumbnail images included in the set of time-based thumbnail images in the time-based transcript at a location in the time-based transcript corresponding to a time point on the timeline where the thumbnail image was displayed in at least one frame of the online course on the display device.

13. The system of claim 12,
wherein the server further includes a scene transition detector, and
wherein the thumbnail generator is further configured to provide the set of time-based thumbnail images to the scene transition detector.

14. The system of claim 13, wherein the scene transition detector is configured to:
identify a scene cut as a time on the timeline where a measurable difference occurs between two consecutive thumbnail images included in the set of time-based thumbnail images; and
generate a subset of the time-based thumbnail images that includes thumbnail images located at identified scene cuts, the subset of the time-based thumbnail images not including duplicate thumbnail images of frames of images that occur between each scene cut.

15. The system of claim 14, wherein receiving the set of time-based thumbnail images by the computing device includes receiving the subset of the time-based thumbnail images.

16. The system of claim 12, wherein the time-based transcript includes a plurality of words and a plurality of time indicators, each time indicator included in the plurality of time indicators being associated with a word from the plurality of words included in the transcript.

17. The system of claim 16, wherein each word included in the plurality of words included in the time-based transcript is associated with at least one of the thumbnail images included in the set of the time-based thumbnail images, the association based on at least a partial overlapping of a time frame associated with a thumbnail image and a time frame associated with an occurrence of the word in the transcript.

18. The system of claim 12, wherein the textbook creator is further configured to store the modified time-based transcript as a digital textbook.

19. The system of claim 12, wherein the transcript editor is further configured to:
receive a selection of a filler included in the time-based transcript for removal from the time-based transcript; and
remove the filler from the time-based transcript, the removing further modifying the time-based transcript.

20. The system of claim 12, wherein the transcript editor is further configured to:
receive input data for including in the time-based transcript; and
add the input data to the time-based transcript, the adding further modifying the time-based transcript.
